(19) United States
(12) Patent Application Publication
(10) Pub. No.: US 2019/0159631 A1
(43) Pub. Date: May 30, 2019

(54) MIXING BOTTLE WITH MAGNETIC MIXING BLADE

(71) Applicant: BevStir Innovations Inc., Port Coquitlam (CA)

(72) Inventor: Anaam Wafa, Long Beach, NY (US)

(73) Assignee: BevStir Innovations Inc., Port Coquitlam (CA)

(21) Appl. No.: 16/313,382

(22) PCT Filed: Feb. 24, 2017
(86) PCT No.: PCT/CA2017/050245

§ 371 Date: Dec. 26, 2018

Related U.S. Application Data
(60) Provisional application No. 62/353,554, filed on Jun. 23, 2016.

(51) Int. Cl. A47J 43/046; A47J 43/27; B01F 3/12; B01F 13/08; A47G 19/22; A47G 23/02; H02J 7/00

(52) U.S. Cl. CPC A47J 43/0465; A47J 43/27; B01F 3/1221; B01F 13/0818; H02J 2007/0062; A47G 23/0241; H02J 7/0052; B01F 2215/0022; B01F 2215/007; A47G 19/2205

(57) ABSTRACT

A portable bottle which is motorized and magnetically linked to a mixing blade. Once the motor is activated by depressing the ON/OFF button, the magnetic attraction between the motor and the mixing blade rotates the mixing blade at the same speed. The lack of a physical shaft running through the bottle provides a completely leak-proof container. The mixing blade is also magnetically attached to the base of the bottle and is removable for easy cleaning.

### FIELD OF THE INVENTION

This invention relates to a mixing bottle. In particular, this invention relates to a mixing bottle that may be used to mix liquids and powders.

### BACKGROUND OF THE INVENTION

Mixing liquids and powders outside of the home can be difficult. For instance, individuals who go to the gym often drink protein formulas that come in powdered form which need to be mixed with a liquid. Protein shaker bottles are commonly used to mix such drinks. However, physically shaking such bottles can be inconvenient, tiring, and tedious. Additionally, the physical shaking may result in inadequate mixing.

In another example, parents may need to prepare baby formula outside of the home. Some mixing bottles have motors with a physical shaft that connects the powered motor to the mixing blades at the base of the bottle through a hole. However, the hole leads to structural weakness and leaks. Since the blades are attached to the base of the container, thorough cleaning is extremely difficult.

It is therefore an object of this invention to provide a mixing bottle that does not require physical shaking.

It is a further object of the invention to provide a mixing bottle that overcomes the leaking problems associates with other mixing bottles.

It is a further object of the invention to provide a mixing bottle with a blade that can be easily and thoroughly cleaned.

These and other objects of the invention will be better understood by reference to the detailed description of the preferred embodiment which follows. Note that the objects referred to above are statements of what motivated the invention rather than promises. Not all of the objects are necessarily met by all embodiments of the invention described below or by the invention defined by each of the claims.

### SUMMARY OF THE INVENTION

In one aspect, the invention comprises a bottle for mixing liquids with powders. The base of the bottle has a centrally embedded magnet. A removable mixing blade having a central magnet and one or more peripheral magnets is used with the bottle. The central magnet of the mixing blade magnetically couples with the magnet that is centrally embedded in the container's base. This magnetic coupling keeps the blade attached the base when a user inverts the bottle for consumption of the mixed beverage. The blade's peripheral magnets couple to a motor unit that is coupled under the base of the bottle. When the motor unit is powered, the magnetic coupling between the blade's peripheral magnets and the magnetic stirrer causes the blade to spin at the base of the bottle.

The bottle utilizes a mixing blade that is magnetically linked to the base of the bottle so as to provide stable and powerful transfer of rotation from the motor to the blade and to prevent the blade from detaching when the user inverts the bottle for consumption of the mixed beverage.

The mixing blade is magnetically coupled to a powered DC motor so there is no need for a physical connection. The advantage to this device is that all the electronic components are completely separated from the bottle with no physical shaft needed to turn the mixing blade. Another advantage is that the mixing blade can be completely and easily removed. The device is powered by a removable lithium polymer battery. The mixing function activates once the ON Off switch is pressed to the ON position. The lithium battery is charged using an onboard micro USB port which utilizes a charge controller.

The bottle is designed in such a manner as to easily be able to fit in a car cup holder for easy transport. The mixing blade is detachable and attaches to the bottom of the inside of the bottle by magnetic attraction. The mixing blade is coupled to the motor through magnetic attraction and rotates at the same speed as the motor.

In another aspect, a mixing container assembly comprises a container and an unattached mixing blade. The container has a base having a fixed magnet, an opening, and a wall extending between the base and the opening. The unattached mixing blade has a mixing blade body and one or more extensions extending from the mixing blade body. The mixing blade body has a body magnet and the one or more extensions each have an extension magnet. The body magnet of the mixing blade body magnetically couples to the fixed base magnet of the base when the unattached mixing blade is placed in the container.

In a further aspect, the mixing container assembly has a magnetic stirrer attachable to the base of the container. The magnetic stirrer has one or more rotor magnets that magnetically couple with the extension magnet(s) of the one or more extensions when the unattached mixing blade is placed in the container.

In another aspect, the magnetic stirrer has a removable lithium battery as a primary source of power.

In another aspect, the magnetic stirrer has a USB charging port.

In another aspect, the mixing container is a wine decanter.

In a further aspect, the invention comprises a mixing blade having a central magnet and at least one peripheral magnet.

The foregoing may cover only some of the aspects of the invention. Other aspects of the invention may be appreciated by reference to the following description of at least one preferred mode for carrying out the invention in terms of one or more examples. The following mode(s) for carrying out the invention is not a definition of the invention itself, but is only an example that embodies the inventive features of the invention.

### BRIEF DESCRIPTION OF THE DRAWINGS

At least one mode for carrying out the invention in terms of one or more examples will be described by reference to the drawings thereof in which:

FIG. 1 is a perspective view of the mixing bottle assembly according to a first embodiment of the invention;

FIG. 2 is a perspective view of the first embodiment with the bottle separated from the magnetic stirrer;

FIG. 3 is a perspective view of the first embodiment with the mixing blade raised outside of the bottle;

FIG. 4 is a perspective exploded view of the first embodiment;

FIG. 5 is a top perspective view of the magnetic stirrer of the first embodiment with the magnetic stirrer top cover removed and set to the side;

FIG. 6 is a top perspective view of the magnetic stirrer shown in FIG. 5 without the rotor;

FIG. 7 is a partial perspective view of the mixing bottle assembly of the first embodiment showing the alignment of the mixing blade and rotor.

FIG. 8 is a perspective view of a mixing bottle assembly according to a second embodiment of the invention;

FIG. 9 is a perspective view of the magnetic stirrer, mixing blade, and bottle of the second embodiment;

FIG. 10 is a perspective view of the mixing blade of the second embodiment shown in isolation; and

FIG. 11 is a perspective view showing a user holding the mixing bottle assembly of the second embodiment in an inverted position.

### DETAILED DESCRIPTION OF AT LEAST ONE MODE FOR CARRYING OUT THE INVENTION IN TERMS OF EXAMPLE(S)

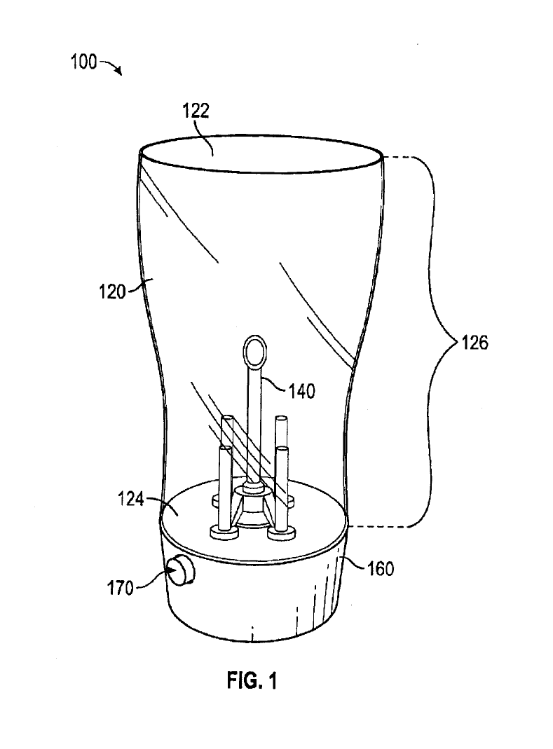

FIG. 1 shows a mixing bottle assembly 100 according to one embodiment of the invention. The mixing bottle assembly 100 comprises a bottle 120, a mixing blade 140, and a magnetic stirrer 160.

The bottle 120 has an opening 122, a base 124, and a wall 126 extending from the base 124 to the opening 122.

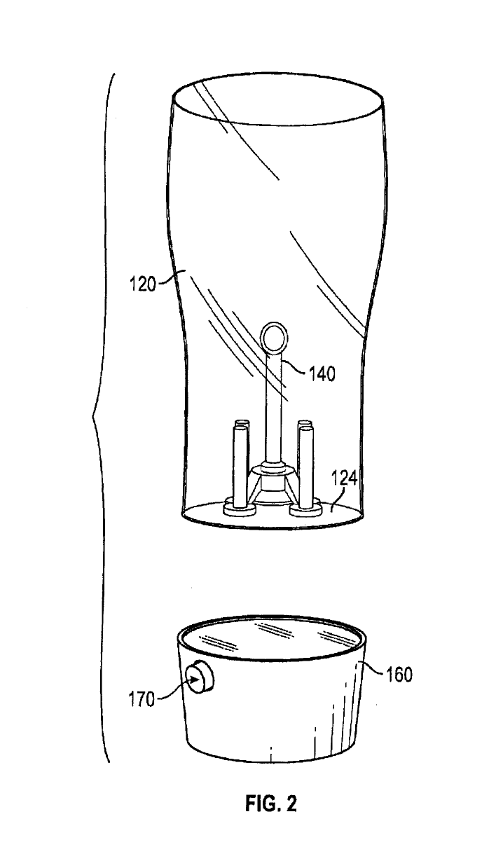

As shown in FIG. 2, the magnetic stirrer 160 may be detachable from the bottle 120. The magnetic stirrer 160 is sized to allow for insertion into standard automobile cup holders.

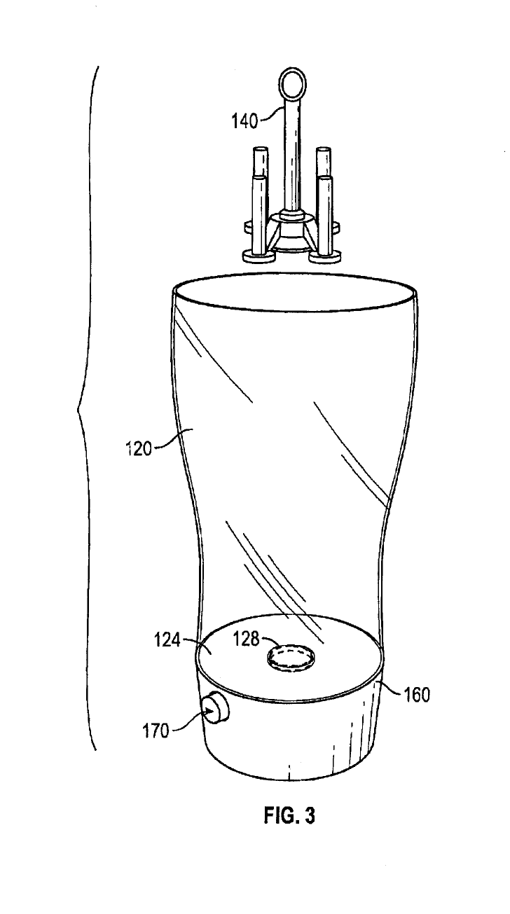

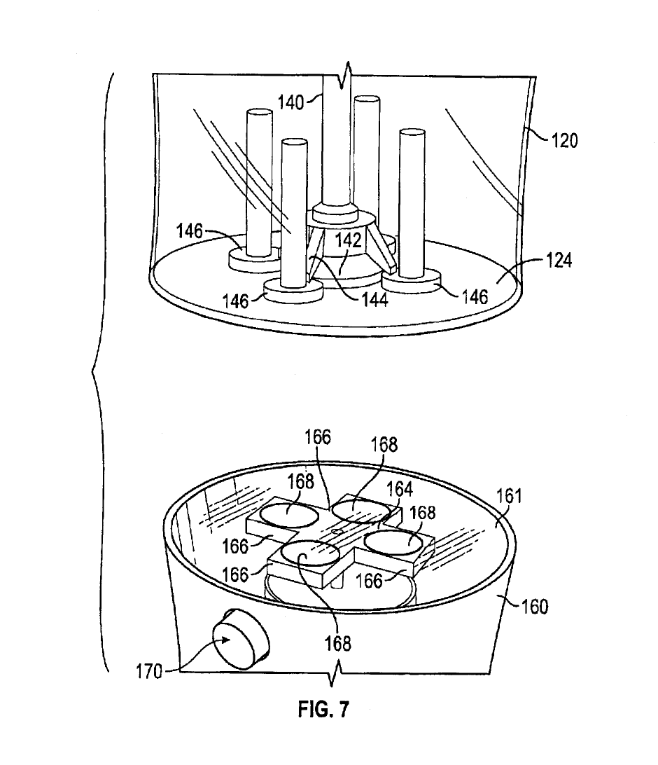

The mixing blade 140 is not physically attached to the base 124 of the bottle 120. As show in FIG. 3, the mixing blade 140 is removable from the bottle 120. Now referring to FIG. 7, the mixing blade 140 has a body 142 that has a body magnet.

The body magnet may be housed within the body 142 or may be attached to the body 142. The mixing blade also one or more extensions 144 that extend outwards from the body 142. Each of the extensions has an extension magnet 146 that abuts the base 124 or lies in close proximity to the base 124 when the mixing blade is placed in the bottle 120.

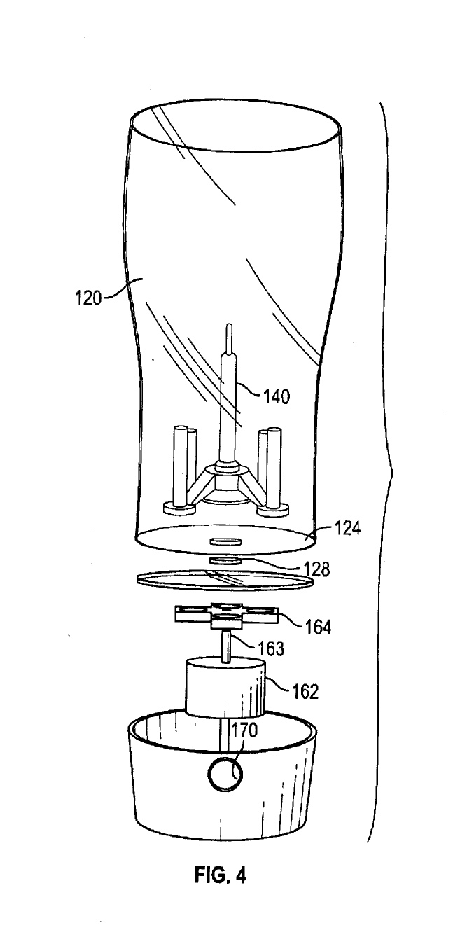

The base 124 of the bottle 120 contains a fixed magnet 128. FIG. 4 shows that the fixed magnet 128 may be secured under the base 124 of the bottle 120. Alternatively, fixed magnet 128 may be secured within base 124 of bottle 120. The fixed magnet 128 is preferably mounted permanently at or near the centre of the base 124.

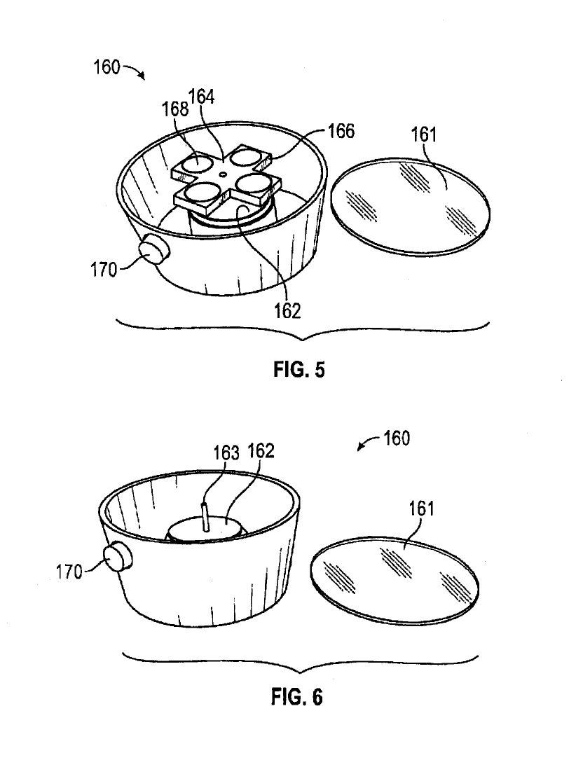

FIGS. 5 and 6 show the magnetic stirrer 106 with the top 161 removed and set to the side. The magnetic stirrer 160 contains a motor 162 and rotor 164. The motor 162 has a shaft 163 and the rotor 164 is mounted on the shaft 163. The particular rotor 164 shown has four extensions 166, each extension 166 having a rotor magnet 168.

When the mixing blade 140 is placed into the bottle 120, the body magnet of the body 142 magnetically couples with the fixed magnet 128 of the base 124. This magnetic coupling keeps the mixing blade 140 centered about the fixed magnet 128 and retains the mixing blade 140 at the base 124 when the bottle 120 is inverted.

In FIG. 7, the top 161 of the magnetic stirrer 160 is illustrated as being transparent so that the rotor 164 may be seen. When the bottle 120 is placed on top of or secured to the magnetic stirrer 160, the extension magnets 146 of the mixing blade 140 magnetically couple with the rotor magnets 168 across the base 124 of the bottle 120. It will be appreciated that alternate configurations of mixing blade 140 and rotor 164 are possible including configurations with a different number of extensions and magnets.

The magnetic stirrer may be powered in a variety of ways, including by way of a removable lithium battery. The battery may be recharged by means of a USB charging port disposed on the magnetic stirrer.

When the magnetic stirrer is powered, by pressing an On/Off switch 170, the motor 162 causes the rotor 164 to spin. The magnetic coupling between the rotor magnets 168 and the extension magnets 146 of the mixing blade causes the mixing blade 140 to spin within the bottle 120 at the same rotational speed and without the need for any physical connections between the mixing blade 140 and the magnetic stirrer 160. This rotation of the mixing blade 140 within the bottle 120 results in the mixture of substances placed within the bottle 120 such as water and a protein formula in a powdered form. The mixing blade 140 may also have a food safe ball bearing mounted to it to allow the mixing blade to easily rotate on its axis during mixing. The bottle 120 may be sealed with a lid until opened by a user to consume the mixed substances.

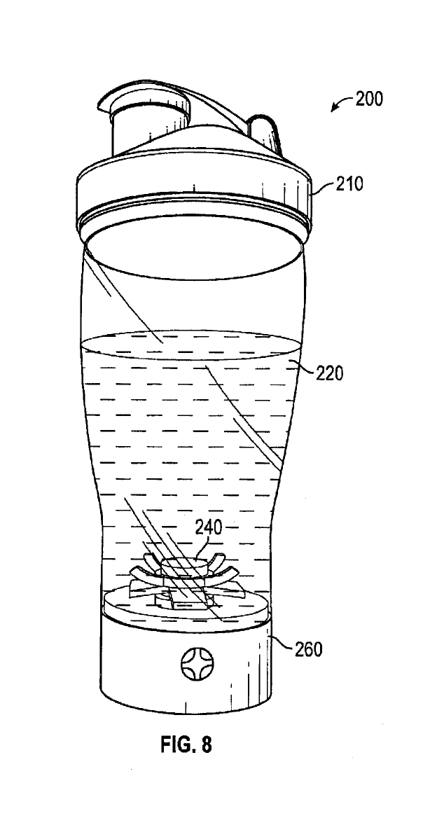

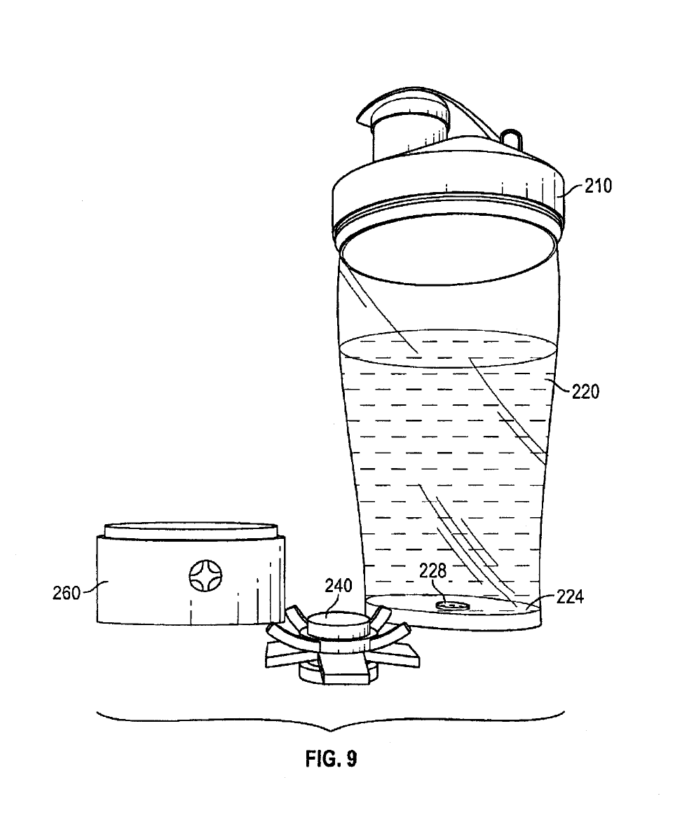

FIG. 8 shows an alternate embodiment of the mixing bottle assembly 200 having a bottle 220, a lid 210, a mixing blade 240, and a magnetic stirrer 260. As best seen in FIG. 9 showing the bottle 220 separated from the magnetic stirrer 260 and the mixing blade 240 removed from the bottle 220, the bottle 220 has a fixed magnet 228 at or substantially near the centre of the base 224 of the bottle 220.

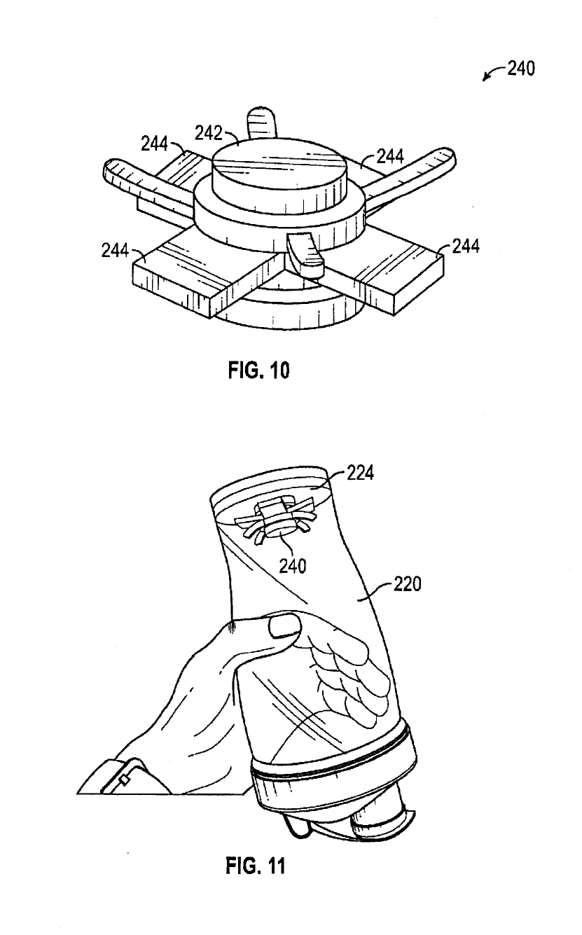

Now referring to FIG. 10, the mixing blade 240 has a body 242 and extensions 244 that project outwards from the body 242. The body 242 contains an internal or external magnet that magnetically couples with the fixed magnet 228 when the mixing blade 240 is placed into the bottle. This magnetic coupling keeps the mixing blade 240 secured to the base 224 of the bottle 220 when the bottle 220 is inverted (as shown in FIG. 11).

Each extension 244 of the mixing blade contains a magnet that couples with magnets in the magnetic stirrer 260 across the base 224 of the bottle 220. When the magnetic stirrer 260 is powered, this magnetic coupling causes the mixing blade 240 to spin with the bottle 220 to mix the bottle's contents.

While the term “bottle” is used throughout the description to describe the invention, it will be appreciated that other types of containers are possible. For instance, a container having a base with a fixed magnet may be a wine decanter. In the wine decanter example, mixing using the unattached mixing blade functions to aerate the wine within the container.

In the foregoing description, exemplary modes for carrying out the invention in terms of examples have been described. However, the scope of the claims should not be limited by those examples, but should be given the broadest interpretation consistent with the description as a whole. The specification and drawings are, accordingly, to be regarded in an illustrative rather than a restrictive sense.

1. A mixing container assembly comprising:
a container comprising:
a base having a fixed magnet;
an opening;
a wall extending between said base and said opening; and
an unattached mixing blade comprising:
a mixing blade body having a body magnet; and
one or more extensions extending from said mixing blade body, said one or more extensions each having an extension magnet;
wherein said body magnet of said mixing blade body magnetically couples to said fixed base magnet of said base when said unattached mixing blade is placed in said container.

2. The mixing container assembly of claim 1 further comprising a magnetic stirrer attachable to the base of said container, said magnetic stirrer having one or more rotor magnets that magnetically couple with the extension magnet(s) of said one or more extensions when said unattached mixing blade is placed in said container.

3. The mixing container assembly of claim 1 wherein said container is a wine decanter.

4. The mixing container assembly of claim 2 wherein said magnetic stirrer has a removable lithium battery as a primary source of power.

5. The mixing container assembly of claim 2 wherein said magnetic stirrer has a USB charging port.

6. A mixing blade having a central magnet and at least one peripheral magnet.
